(19) United States
(12) Patent Application Publication
(10) Pub. No.: US 2011/0106536 A1
(43) Pub. Date: May 5, 2011

(54) SYSTEMS AND METHODS FOR SIMULATING DIALOG BETWEEN A USER AND MEDIA EQUIPMENT DEVICE

(75) Inventor: Walter Richard Klappert, Los Angeles, CA (US)

(73) Assignee: ROVI TECHNOLOGIES CORPORATION, Los Angeles, CA (US)

(21) Appl. No.: 12/608,245

(22) Filed: Oct. 29, 2009

(51) Int. Cl. G10L 15/00; G06F 17/20; G06F 3/048

(52) U.S. Cl. 704/246; 715/720; 706/11

(57) ABSTRACT

Systems and methods for simulating dialog between a user and a media equipment device are provided. Videos of a user selected actor may be retrieved. An opener video of the selected actor may be displayed and based on a verbal response received from the user, a clip of a media asset associated with the selected actor may be retrieved. User reactions to the displayed clip may be monitored and subsequent videos of the actor and clips may be provided based on the user reactions. Clips of a media asset that matches preferences of the user may be retrieved. A clip associated with a mid level rank may be displayed. When the user reacts positively to the clip a clip associated with a low class level rank may be retrieved next otherwise a high class level rank clip may be retrieved next.

### BACKGROUND OF THE INVENTION

Traditional systems provide branching stories that allow a user to select the sequencing of scenes of a video based on the desires of the user. For example, a video may display a scene in which a group has the option to fight or run away and may query the user as to which branch to take. The user may select the fight branch and as a result a fight scene of the video will be displayed or alternatively, the user may select the run away branch and as a result a scene in which the group runs away will be displayed.

Although these systems are capable of determining in which direction to branch based on verbal commands from the user, the verbal commands must match precisely one of the branch path options. In particular, the traditional systems are incapable of seamlessly handling uncertainty with regard to verbal commands received that do not match a particular branch path option. Additionally, the traditional systems have no means to automatically determine which branch path to select without explicit instructions from the user and therefore cannot select a particular branch path that matches the user's interests.

### SUMMARY OF THE INVENTION

In view of the foregoing, systems and methods for simulating dialog between a user and a media equipment device in accordance with various embodiments of the present invention are provided. In particular, videos in which an actor appears to respond to verbal input received from the user are displayed based on the received verbal input and media assets are retrieved for display based on the user's verbal reactions to displayed content. The dialog between the actor and the user continues notwithstanding any uncertainty of the verbal input that is received.

In some embodiments, a plurality of videos of a user selected actor may be stored. The actor may communicate a different message in each of the plurality of videos. A plurality of clips of a media asset associated with the actor may be stored. Upon receiving indication from the user to start a simulated dialog with the actor, a variable length sequence of media may be displayed.

In some embodiments, the variable length sequence of media may include first and second videos of the plurality of videos of the actor and at least one of the plurality clips of the media asset associated with the actor. The at least one of the clips is in the sequence of media may be displayed in the sequence between the first and second videos of the actor. The first video of the actor may be an opener video in which the message communicated by the actor starts a dialog and the second video of the actor may be a closer video in which the message communicated by the actor ends the dialog.

In some embodiments, verbal input (e.g., utterances) of the user may be monitored as the first video in the sequence is displayed. A determination is made as to which of the plurality of clips to display next in the sequence following the first video as the at least one of the clips in the sequence of media based on the monitored verbal input. In some implementations, further verbal input may continuously be monitored as each media in the sequence is displayed. At least one of a third video of the plurality of videos of the actor and another clip of the plurality of clips may be selected based on the monitored further verbal input. An addition, to the sequence of media, of the selected at least one of the third video and another clip is made where the length of the sequence varies based on the addition.

In some embodiments, a user selection of an actor is received and a request to have a simulated dialog with the selected actor is received. The request to have a simulated dialog may be verbally spoken or provided using an input device. An opener video of the actor may be provided and a verbal response from the user is received.

In some embodiments, the verbal response of the user may be processed accounting for uncertainty. In particular, the verbal response may not match an expected response and accordingly, the system may execute a ploy. In some embodiments, the ploy may be executed by retrieving for display a ploy type banter video of the selected actor. In some implementations, the ploy type banter video of the selected actor may have the actor communicate a message that appears to rephrase portions of the verbal response that are successfully processed. In some implementations, the ploy type banter video of the selected actor may have the selected actor communicate a message that changes the topic of conversation. In some implementations, the ploy type banter video of the selected actor may have the selected actor appear interested to the user to provide a delay and cause the user to repeat the verbal response.

In some embodiments, based on the verbal response of the user, a clip of a media asset associated with the selected actor may be retrieved. In some implementations, the clip of the media asset may be automatically recorded as the simulated dialog progresses or may be retrieved from a local or remote storage device (e.g., a website). A video of the selected actor in which the actor communicates a message introducing the clip may be retrieved and displayed prior to the display of the clip. Reactions of the user to the display of the retrieved clip may be monitored to determine whether the reactions are positive (e.g., indicating the user liked or enjoyed the clip) or negative (e.g., indicating the user did not like or enjoy the clip).

In some embodiments, further banter videos of the selected actor and clips of the media asset associated with the selected actor may be retrieved based on the verbal responses of the user and the monitored reactions. In some implementations, after a predetermined period of time (e.g., 30 minutes) or after a predetermined number of clips (e.g., five clips) have been provided, the simulated dialog may be terminated. In some implementations, the simulated dialog may be terminated upon specific request (verbal or otherwise) from the user or when a predetermined number of negative reactions (e.g., more than three) have been monitored. In some embodiments, a closer video of the selected actor may be retrieved for display in which the actor communicates a message ending the simulated dialog. In some embodiments, commercials or advertisements may be provided between the display of an actor video and a clip of a media asset associated with the actor.

In some embodiments, a plurality of clips of a media asset that matches user preferences may be retrieved. In some implementations, the media asset may be identified by processing preferences stored in a user preference profile. The clips of the media asset may be retrieved from local or remote storage (e.g., a website). Each of the clips may be associated with a class level rank (e.g., high, mid, or low) and may also be associated with an individual rank.

In some embodiments, a first of the clips of the media asset that has a mid class level rank may be displayed. Reactions of the user to the display of the clip having the mid class level rank may be monitored to determine whether the reactions are positive (e.g., indicating the user liked or enjoyed the clip) or negative (e.g., indicating the user did not like or enjoy the clip). A subsequent clip may be selected among the clips for display based on the monitored reaction. In particular, when the reactions of the use are determined to be positive, the subsequent clip that is selected may be associated with a class level rank lower than the previously displayed clip (e.g., low class level rank). Alternatively, when the reactions of the use are determined to be negative, the subsequent clip that is selected may be associated with a class level rank higher than the previously displayed clip (e.g., high class level rank).

In some embodiments, after a predetermined period of time or after a predetermined number of clips have been displayed, a last clip may be selected for display. In some implementations, the last clip may be selected based on the last monitored user reaction. In particular, when the last user reaction was determined to be positive, the last clip may not be displayed and the interaction may be terminated. Alternatively, when the last user reaction was determined to be negative, a clip being associated with the high class level rank and being associated with an individual rank higher than a majority of the clips associated with the high class level rank may be selected for display as the last clip.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 is an illustrative display screen of an actor dialog simulation main menu in accordance with an embodiment of the invention;

FIG. 6 is an illustrative display of a variable length sequence of media on a screen in accordance with an embodiment of the invention;

FIG. 7 is an illustrative actor dialog simulation system in accordance with an embodiment of the invention;

FIG. 8 is an illustrative user voice profile data structure in accordance with an embodiment of the invention;

FIG. 9 is an illustrative actor profile data structure in accordance with an embodiment of the invention;

FIGS. 10 and 11 are illustrative flow diagrams for providing dialog simulation with an actor in accordance with embodiments of the present invention; and

FIG. 12 is an illustrative flow diagram for providing media asset clips based on user reactions in accordance with embodiments of the present invention.

### DETAILED DESCRIPTION

This invention generally relates to systems and methods for simulating dialog between a user and a media equipment device. In particular, videos in which an actor appears to respond to verbal input received from the user are displayed based on the received verbal input and media assets are retrieved for display based on the user's verbal reactions to displayed content. As defined herein the term “actor” is any personality, celebrity, news anchor, television star, well known person or object, closely known person (e.g., family member, relative, colleague or friend), cartoon character, robot, or other simulation or representation of an intelligent or artificially intelligent being.

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

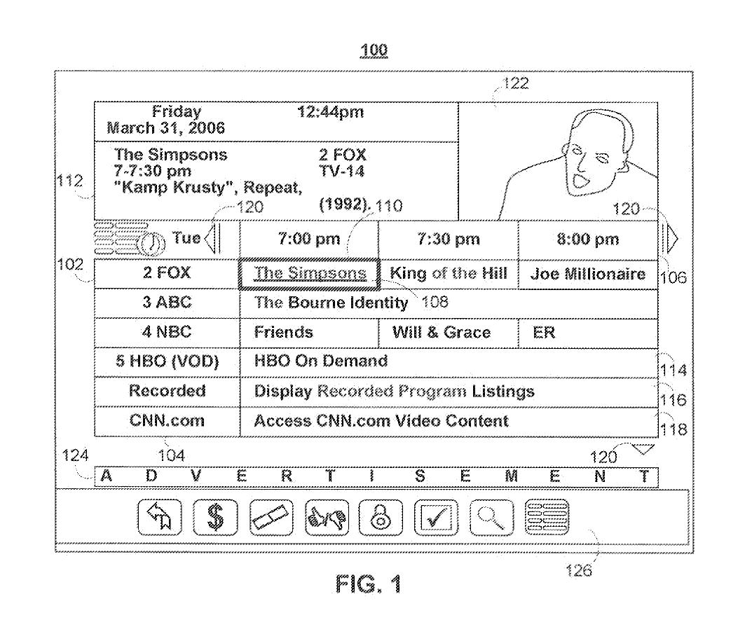

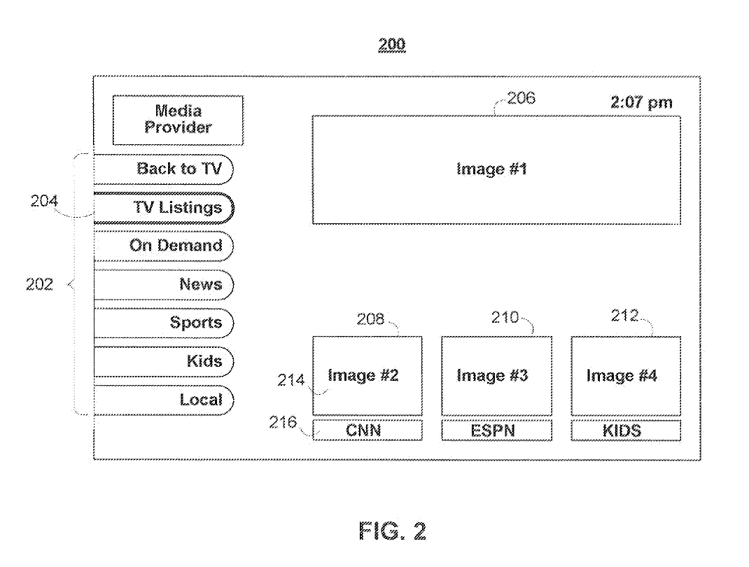

One of the functions of the media guidance application is to provide media listings and media information to users. FIGS. 1-2 show illustrative display screens that may be used to provide media guidance, and in particular media listings. The display screens shown in FIGS. 1-2 and 5-6 may be implemented on any suitable device or platform. While the displays of FIGS. 1-2 and 5-6 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site (e.g., HULU or YOUTUBE) or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to (i.e., be related to) or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,814, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, scheduling a reminder for a program, ordering a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. Pat. No. 7,165,098, issued Jan. 16, 2007, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, still frames of a video associated with the listing, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

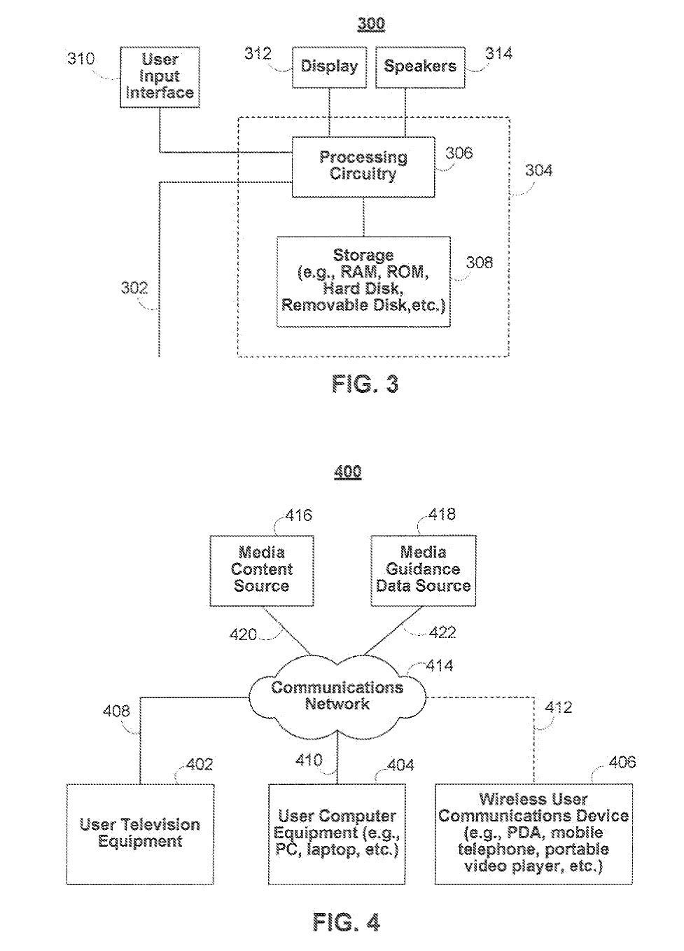

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300 (e.g., a media equipment device). In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 (e.g., the media equipment device) of FIG. 3 can be implemented in system 400 of FIG. 4 as user television equipment 402, user computer equipment 404, wireless user communications device 406, or any other type of user equipment suitable for accessing media, such as a non-portable gaming machine or a robot. For simplicity, these devices may be referred to herein collectively as user equipment or user equipment devices or media equipment device(s). User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a robot, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content or scheduled media asset events (e.g., reminders for media assets). For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, program orders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,914, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In some embodiments, a dialog may be simulated between an actor and a user. In particular, processing circuitry 306 may allow the user to select a particular actor with which to have a dialog and videos of the actor may be retrieved and displayed. The videos that are retrieved and displayed may include messages provided by the selected actor which resemble the messages that would be provided by the actor in a real conversation with the user. For example, when the user initially starts the conversation, a first video of the selected actor may be retrieved and displayed in which the actor communicates an opening message, such as, “Hello, how are you doing today?”

The user may respond verbally to the messages provided by the actor in the displayed videos. Processing circuitry 306 may perform one or more voice recognition algorithms on the received verbal response to determine which video of the actor to retrieve for display next. For example, when the voice recognition algorithm determines that the verbal response included an utterance that matches an utterance associated with sadness (e.g., utterance is “ad” corresponding to the user verbal response “sad”) the next video of the actor may include a message that asks “Why are you sad?” The dialog may continue in such a manner until processing circuitry 306 or the user decides to end the dialog. When the dialog is to be terminated, a video of the actor may be retrieved and displayed in which the actor communicates a closing message, such as “It was nice talking to you again.”

In some embodiments, processing circuitry 306 may retrieve one or more videos of the actor that guide the dialog in a certain direction. In particular, processing circuitry 306 may retrieve and display videos of the actor that guide the dialog in a direction that promotes, advertises or exposes the user to one or more media assets that are associated with the actor. For example, the actor or in such a case actress may be Meredith Vieira who has an associated media asset on channel NBC with the title “Today Show”. Accordingly, the user may have a dialog with the actress Meredith about the media asset “Today Show” which may begin with an opener video of Meredith asking the user “Hi! Did you see the show “Today?” Based on the verbal response of the user, a subsequent video of the actress may be retrieved for display.

For example, when the verbal response is determined to indicate that the user did not see the show or media asset, a video of the actress describing the associated media asset may be retrieved and displayed. In some implementations, a clip from the media asset associated with the actor may be retrieved and displayed. Alternatively, when the verbal response is determined to indicate that the user did see the show or media asset associated with the actress, a video of the actress describing footage of the associated media asset that was not broadcast may be retrieved and displayed. In some implementations, a clip of the footage that was not broadcast of the media asset associated with the actor may be retrieved and displayed.

As defined herein the term clip or segment means a short video and/or audio piece of the longer corresponding media asset. In particular, a clip or segment may be a short 5-10 minute or second video portion (e.g., beginning, middle or end portion) of the corresponding video media asset. Any length shorter than the corresponding media asset may be provided for the clip or segment.

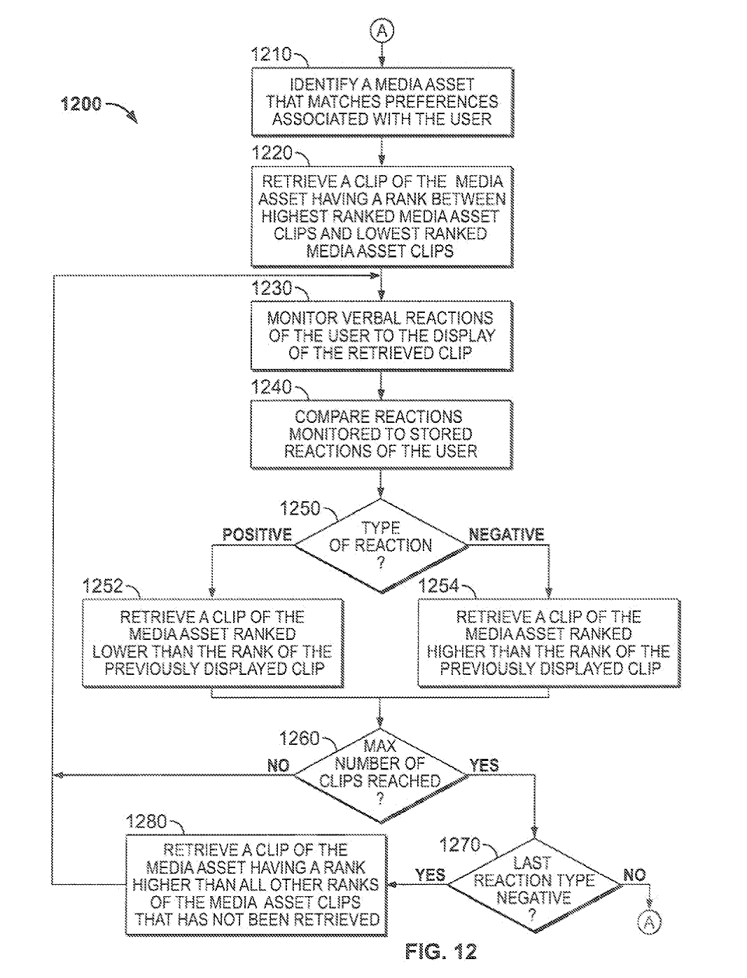

In some embodiments, processing circuitry 306 may retrieve a plurality of clips of a particular media asset. In some implementations, the retrieved clips may be associated with different ranks. Processing circuitry 306 may monitor reactions of the user to one of the displayed clips and retrieve another clip that has a rank different from the displayed clip based on the reaction. For example, when the monitored reaction to the displayed clip is positive, processing circuitry 306 may retrieve for display another clip that has a lower ranking than the displayed clip. The process of selecting clips for display based on monitored user reactions is discussed below in more detail in connection with FIG. 12.

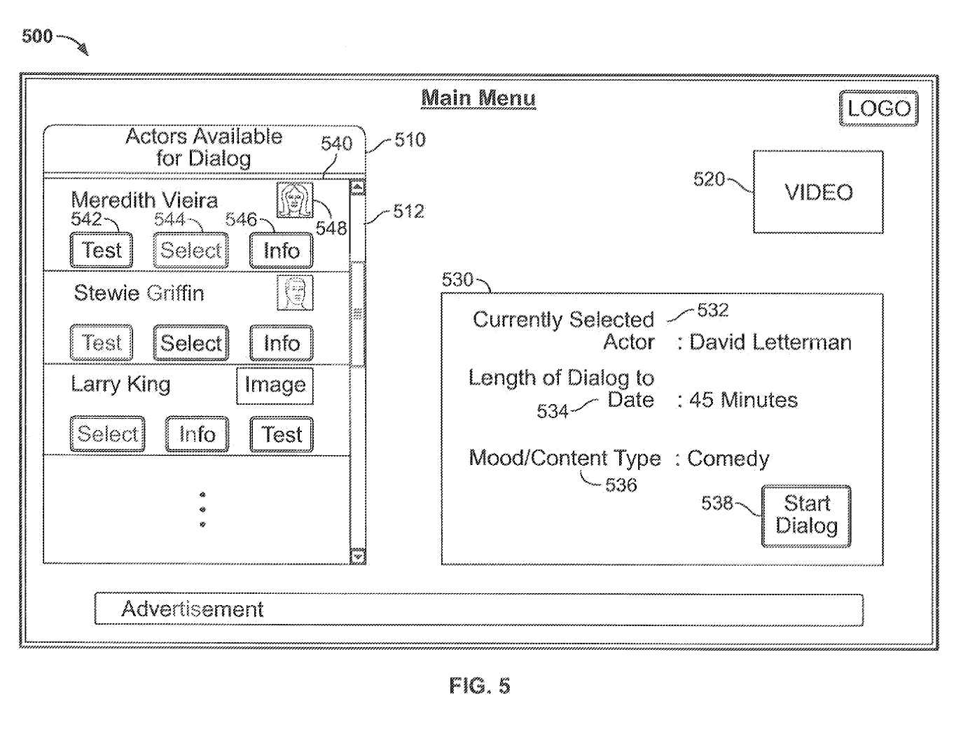

FIG. 5 is an illustrative display screen 500 of an actor dialog simulation main menu in accordance with an embodiment of the invention. Screen 500 may include an actor selection region 510, a video region 520 and current selection information region 530. Screen 500 may be a configuration screen provided by processing circuitry 306 as a result of the user requesting to set up the dialog with an actor. In particular, screen 500 may allow the user to configure with whom the user would like to have a dialog and to also create a user voice profile for the user.

Actor selection region 510 may include actor listings 540 corresponding to actors that are available for dialog simulation. In particular, each actor listing may correspond to a set of videos associated with that actor in which the actor communicates a message (e.g., opener, banter, and closer) to the user. The actor videos may be stored remotely or locally in a memory. Scroll bar 512 may be included in actor selection region 510. Processing circuitry 306 may receive a user selection to move scroll bar 512 up/down to view previous/next actor listings 540 which may not be in current view of actor selection region 510.

In some embodiments, some of actor listings 540 may be free of charge and may include an identifier indicating that the dialog with the corresponding actor is provided without cost. Additionally, some of actor listings 540 may require the user to subscribe or provide payment to have a dialog with the corresponding actor. In particular, some of actor listings 540 may behave more like pay-per-view channels which may be more popular than others and are provided at a premium price. In some implementations, dialogs with actors that are provided for free may include one or more commercial breaks throughout the dialog and/or advertisement segments whereas dialogs with actors that are provided at a premium may be provided commercial free (e.g., without commercial interruptions or advertisements). Each actor listing 540 may include a popularity information region which informs the user of how many other users in a specified network have selected that actor to have a simulated dialog. The popularity information region may include a field which informs the user of how long each dialog simulation lasted with each actor.

Each actor listing 540 may include a unique actor identifier 548 that identifies the actor associated with actor listing 540 to the user. In some implementations, unique actor identifier 548 may be an image, video, clip and/or sound bite of the actor. For example, unique actor identifier 548 may be a photograph of the actor. In some implementations, unique actor identifier 548 may be a video, clip, and/or sound bite associated with a media asset corresponding to the actor. For example, for the actress Meredith Vieira, unique actor identifier 548 may be a cover image, introduction segment, or theme song of the media asset “Today Show” with which the actress is associated and which the user may associate with the actress.

Each actor listing 540 may include a test option 542. Processing circuitry 306 may receive a user selection of test option 542 and as a result may retrieve a random or dedicated video of the actor corresponding to actor listing 540. For example, the dedicated video of the actor for test option 542 may be a video in which the actor communicates a message introducing the actor to the user and urging the user to select the actor listing 540. The video of the actor for the test option 542 may also include some introductory content about one or more media asset associated with the actor to allow the user to decide whether or not the user is interested in the content associated with the actor. Processing circuitry 306 may cause the retrieved test video of the actor to be displayed in video region 520. In some embodiments, video region 520 may also display the currently tuned television channel or previously accessed media asset. For example, the user may continue to view a media asset being streamed through video region 520 while making modifications or providing configurations to actor dialog configuration screen 500.

Each actor listing 540 may include an information option 546. Processing circuitry 306 may receive a user selection of information option 546 and as a result may provide a display screen as a prompt or may navigate the user to a new screen that includes information about the actor associated with actor listing 540. For example, the information about the actor may include a list of media asset associated with the actor, background information about the actor, likes/dislikes of the actor, political views of the actor, and/or a general description by way of a genre assignment of the type of content associated with the actor. In particular, the information region may include a genre assignment of comedy for the actor Stewie Griffin since that actor is associated with the media asset “Family Guy” which is a comedy. More specifically, the dialog the user may have with the actor Stewie Griffin may include clips of the media asset “Family Guy” which may be funny. The user may read the information associated with different actors to decide which actor matches the user's interests and would provide for a fun and entertaining dialog simulation.

Each actor listing 540 may include a select option 544. Processing circuitry 306 may receive a user selection of select option 544 and as a result may retrieve videos of the actor and store the retrieve videos of the actor locally. For example, processing circuitry 306 may retrieve opener videos of the actor, banter videos of the actor and closer videos of the actor from a remote media server and store the retrieved videos locally. Processing circuitry 306 may cause the stored videos of the actor corresponding to the selected actor listing 540 to be displayed when simulating a dialog between the actor and the user. In some embodiments, dialog simulation with the selected actor may begin when processing circuitry 306 receives a user selection of start dialog option 538. In some embodiments, dialog simulation with the selected actor may begin when the user tunes or selects an on-demand program listing from program listings display 100 (FIG. 1).

In some embodiments, processing circuitry 306 may sense the presence of the user and may automatically retrieve the corresponding voice profile 800 of the user and start the dialog simulation between the user and a selected actor. For example, processing circuitry 306 may detect that a mobile device (e.g., a mobile phone) associated with the user is within a predetermined communications range (e.g., may communicate via Bluetooth) of the media equipment device. In response to detecting that the mobile device is within the communications range, processing circuitry 306 may retrieve an opener video of the actor the user previously selected and start the dialog simulation. In some implementations, processing circuitry 306 may be provided with a specified time of when to start dialog simulation. For example, the user may configure processing circuitry 306 to start the dialog simulation every Tuesday and Thursday at 12 PM.

In some embodiments, the user may select more than one actor program listing 540. In particular, processing circuitry 306 may receive a user selection of a first actor program listing 540 and provide a first actor dialog with a first actor when the user is in a happy mood and processing circuitry 306 may receive a user selection of a second actor program listing 540 and provide a second actor dialog with a second actor when the user is in a sad mood. More specifically, the user may configure processing circuitry 306 to provide dialogs with different actors based on how the user is feeling. For example, the user may enjoy talking to a comedian actor like Jerry Seinfeld when the user is upset or sad and the user may enjoy talking to a serious actor like Larry King when the user is not upset or sad. In some implementations, processing circuitry 306 may monitor tones and/or intonations of the voice of the user and may automatically determine the mood of the user. For example, processing circuitry 306 may associate low intonations in voice with a sad mood and high intonations in the voice with a happy mood. In some implementations, processing circuitry 306 may automatically select with which actor to simulate a dialog based on the automatically determined mood of the user.

In some embodiments, some actors corresponding to actor listings 540 may be cartoon characters. For example, selection of actor listing 540 corresponding to actor Stewie Griffin may provide a dialog simulation with the cartoon character from the media asset “Family Guy”. In such implementations, the videos of the actor may be cartoon drawings of the cartoon character communicating messages to the user as discussed above and below in connection with all other actors.

Current selection information region 530 may include information associated with a user that informs the user about the current selections. More specifically, processing circuitry 306 may list each actor that the user selected from actor listings 540 in a list 532 in information region 530. The user may modify and/or remove any of the actors listed in list 532. In particular, the user may associate different actors listed in list 532 with different moods of the user or remove the actors from the list entirely. For example, an actor may be associated with a mood/content type field 536 which informs the user about the type of content (e.g., happy or serious) that is provided by the actor and/or which the user may select to associate a particular mood with the actor. Each actor listed in list 532 may also include a length of dialog field 534 which informs the user of the total length of the simulated dialog the user had with that particular actor. This may allow the user to determine with which actor the user had the longest dialog and decide which actor is the user's favorite.

In some embodiments, the actor may be a friend or relative of the user. For example, the actor may be a girlfriend of the user who records herself making a variety of opener, banter and closer videos. The user may select to have a simulated dialog with the friend or relative and as a result, processing circuitry 306 may retrieve from a storage device associated with the friend or relative the opener, banter and closer videos of the selected friend or relative. The storage device may be a memory at the friend or relative's media equipment device or may be a storage location at a remote storage facility (e.g., website or server).

During the simulated dialog with the friend or relative, a clip of a media asset associated with the friend or relative may be provided between videos of the friend or relative. The clip may be selected based on verbal responses received from the user to the presentation of the video of the friend or relative. The media asset associated with the friend or relative may be selected by the friend or relative. For example, the clips may be of the media asset that is listed as a favorite show of the friend or relative and/or may be clips from a variety of media assets that have been recorded by the friend or relative. This allows friends or relatives to provide simulated dialogs to other users while at the same time presenting the other users with media assets and clips of the media assets that are of interest or associated with the friends or relatives. In some implementations, other users on a network may request permission to receive videos of the friends or relatives so that the other users may also interact by way of having a simulated dialog with the friends or relatives.

In some embodiments, the clips of the media asset presented during the simulated dialog with the actor, friends or relatives may be selected based on a popularity rank associated with the clips (as discussed above and below) such clips associated with higher ranks are displayed when the last reaction of the user is determined to be negative and clips associated with lower ranks are displayed when the last reaction of the user is determined to be positive.

It should be understood that the media asset associated with the actor (friend or relative) discussed above and below is different from the video of the actor (friend or relative) that may be retrieved and displayed. In some implementations, the media asset may be a show or media asset featuring the actor. In some implementations, the media asset may be a show or media asset that is specifically selected or has been recorded by the actor (friend or relative). In particular, the media asset may be a program that is broadcast to a plurality of users while the video of the actor (friend or relative) may be an on-demand video that is retrieved based on a user request and/or verbal responses received from the user. Videos of the actor (friend or relative) may be stored in one storage device or location while the media asset may be stored elsewhere. For example, videos of the actor (friend or relative) may be retrieved from one website or server and the media asset or clips of the media asset associated with the actor (friend or relative) may be retrieved from a different website or server. Preferably, the videos of the actor (friend or relative) only include moving images of the actor (friend or relative) and no other person while the media asset associated with the actor (friend or relative) may include any number of people that are part of the program. In some embodiments, the clip of the media asset associated with the actor may be longer than any video of the actor that is displayed. In some implementations, the clip of the media asset associated with the actor may be longer in runtime than any video of the actor that is displayed by at least one order of magnitude.

In some embodiments, videos of the actor and clips of the media asset associated with the actor may be displayed in a sequence that is adjusted based on verbal responses the user provides. In particular, a first opener type video of the actor may be presented first in the sequence and based on a verbal response of the user, a clip of a media asset associated with the actor may be displayed next in the sequence. After the clip is displayed, a second closer type video of the actor may be presented. More specifically, the videos of the actor and the clips of the media asset associated with the actor may be displayed in a variable length sequence of media.

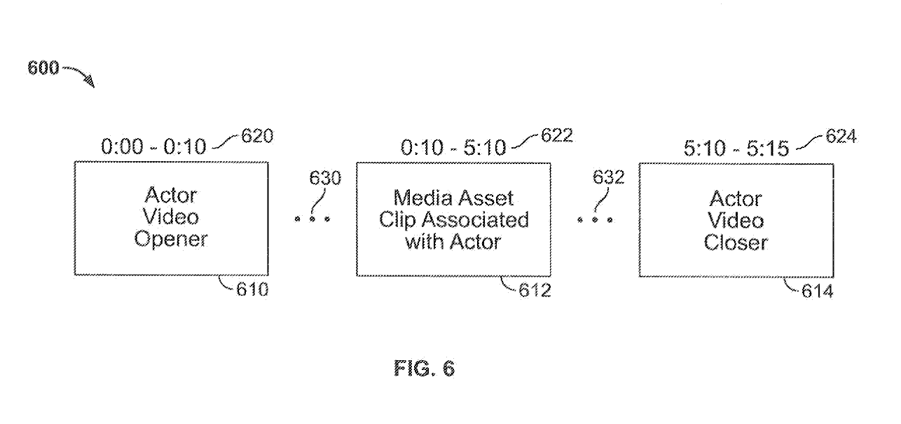

FIG. 6 is an illustrative display 600 of a variable length sequence of media on a screen in accordance with an embodiment of the invention. The display of the variable length sequence of media may be provided for the user by processing circuitry 306 as a result of the user verbally instructing the media equipment device to start a dialog with an actor or when the user selects start dialog option 538. Display 600 may include a first media 610, a second media 612 and a third media 614. A first plurality of media 630 may be provided between first media 610 and second media 612 and a second plurality of media 632 may be provided between second media 612 and third media 614.

Each of media 610, 630, 612, 632 and 614 may be displayed sequentially in one display screen and/or in a picture-in-picture type arrangement. For example, actor video may be displayed in the main picture and clips may be displayed in a smaller picture part of the display or the other way around. In some implementations, as media in the sequence changes from first media 610 to second media 612, first media 610 may be paused and displayed (or the last frame of a video displayed as first media 610 may be displayed) in a smaller section of the display screen (e.g., a picture-in-picture section) and second media 612 may be played back and displayed in the larger section of the screen. In some implementations, first media 610 and second media 612 may overlap portions of the display screen and/or may be made partially transparent such that second media 612 may be viewed through first media 610.

For example, first media 610 may be a video of a selected actor in which the actor communicates an opener type message. First media 610 may have a first runtime 620 of ten seconds. Once first media 610 ends, verbal responses of the user may be monitored and second media 612 may be selected or determined based on the verbal responses received from the user. For example, first media 610 may have the message communicated by the actor ask the user if the user has seen the latest instance of the media asset associated with the actor. When the user responds in the negative (indicating that the user has not seen the latest episode), processing circuitry 306 may determine and select a clip of the latest instance of the media asset associated with the actor for presentation as second media 612. In some implementations, first media 610 may be removed from the display and second media 612 (e.g., the selected clip) may be played back with a second runtime 622 of about five minutes. In some implementations, a last frame of first media 610 (e.g., a last frame of the video of the actor) may be placed in a small picture (picture-in-picture) on the display and second media 612 (e.g., the selected clip) may be played back with a second runtime 622 of about five minutes in the main picture.

Alternatively, when the user responds in the positive (indicating that the user has seen the latest episode), processing circuitry may select another video of the actor which may be a banter type video for presentation as one of the first plurality of media 630 before second media 612. The banter type video may be displayed in the main picture in place of first media 610. In some implementations, when the sequence of media transitions from the display of a video of an actor to another video of an actor, each video of the actor may be displayed in the same location and in the same size (e.g., in the main picture of the display). When the sequence of media transitions from the display of video of the actor to the display of a clip of the media asset, the video of the actor may either be removed from the display and replaced with the clip; may be placed in a smaller section of the display (as a picture-in-picture) such that only the last frame or some other frame of the video of the actor appears in the smaller section while the clip of the media asset is provided in the main larger section of the display; or may be placed in a smaller section of the display (as a picture-in-picture) such that only the last frame or some other frame of the video of the actor appears in the smaller section overlapping (either partially transparent or in an opaque manner) the clip of the media asset provided in the main larger section of the display. Similarly, when the sequence of media transitions from the display of a clip of the media asset to the display of a video of the actor, the clip may either be removed from the display and replaced with the video of the actor; may be placed in a smaller section of the display (as a picture-in-picture) such that only the last frame or some other frame of the clip appears in the smaller section while the video of the actor is provided in the main larger section of the display; or may be placed in a smaller section of the display (as a picture-in-picture) such that only the last frame or some other frame of the clip appears in the smaller section overlapping (either partially transparent or in an opaque manner) the video of the actor provided in the main larger section of the display. It should be understood that when the media asset or clip of the media asset is an audio media asset or clip, the term “display” means the presentation or playback of audio only.

In some embodiments, during presentation of media 612, verbal input from the user may be monitored. In some implementations, the absence of expected verbal input may be detected at one or more portions of playback of media 612. For example, media 612 may be a clip that includes a joke at 3 minutes, 35 seconds into the clip. The expected verbal input in such circumstances may be laughter which may be detected by monitoring the verbal input. In some implementations, as a result of detecting the absence of expected verbal input, the clip may be terminated and third media 614 may be presented or one of second plurality of media 632 may be presented. When second media 612 is terminated before completion (e.g., because of the monitored verbal input or the detected absence of expected verbal input), the length or runtime of the sequence of media that is presented may vary or change. Third media 614 or one of second plurality of media 632 may be selected based on the monitored verbal input or the absence of expected verbal input.

One of second plurality of media 632 that is presented after second media 612 ends or is terminated may be a video of the actor which is a banter type. For example, the video of the actor may include the actor communicating a message about second media 632 or a message introducing another topic or another clip. Third media 614 may be the last media in the sequence of media presented to the user. Third media 614 may be video of the actor which may be a closer type (e.g., the message communicated by the actor ends the dialog) and may have a third runtime 624 of five seconds. In some embodiments, third media 614 that is the last media in the sequence of media presented to the user may be a clip of a media asset associated with the actor having a high ranking or which matches preferences of the user (e.g., is of high interest to the user). The number of clips or videos of the actor presented during the sequence of media display may vary based on the verbal input received from the user. In particular, any number of clips or videos may be added as first and second plurality of media 630 and 632.

In some embodiments, videos of the actors and clips of the media assets associated with the actors may be stored in a remote storage location. Processing circuitry 306 may retrieve from the remote location the videos of the actor as they become necessary.

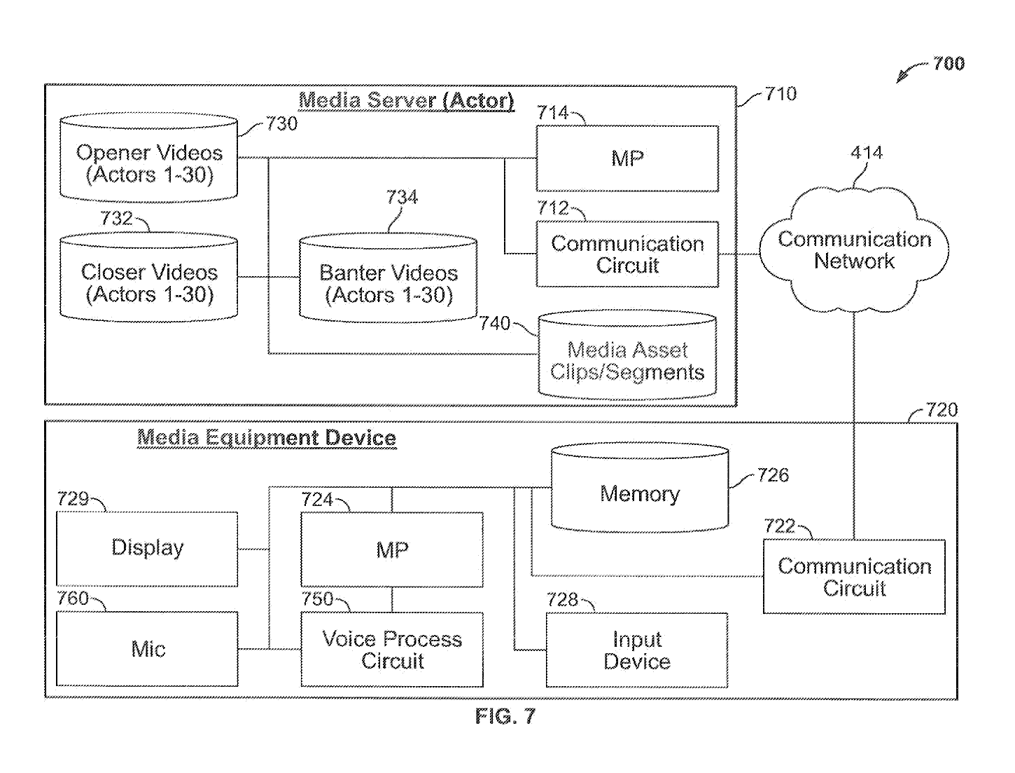

FIG. 7 is an illustrative actor dialog simulation system 700 in accordance with an embodiment of the invention. System 700 may include a media server 710, communications network 414 (FIG. 4) and media equipment device 720. Media server 710 may communicate with media equipment device 720 over communications network 414 using respective communications circuitries 712 and 722. In some implementations, media server 710 may be the same or similar as media content source 416 and media equipment device 720 may be the same or similar as user television equipment 402, user computer equipment 404 and/or wireless user communications device 406 (FIG. 4). In some implementations, media server 710 may be a web server accessible through a website. In particular, media equipment device 720 may retrieve information from media server 710 by accessing a website where the desired content is stored.

Media server 710 may include a microprocessor 714 coupled to actor opener video storage device 730, actor closer videos storage device 732, actor banter videos 734 and media asset clips storage device 740. Opener videos storage device 730 may include videos of one or more actors in which the one or more actors communicate an opener message. Each actor may have a multiple different types of opener message videos stored in opener videos storage device 730. In particular, having multiple different types of opener message videos of the actor allows media equipment device 720 to present different opening dialog videos to the user to avoid repetition.

For example, when the user first has a conversation with actress Meredith Vieira, a first opener video of that actress may be presented to the user in which the opener message may be “Hi! Did you see the show “Today?” When the user previously had a conversation with actress Meredith Vieira, a second opener video of that actress may be presented to the user in which the opener message may be “Hello again! Tired of Michael Jackson? Or, do you want more?” It should be noted, that the second opener video may include content that is carried over from a dialog the user had with the actor in a previous occasion. In particular, the user may have previously indicated to the actor through dialog an interest in the singer Michael Jackson and accordingly a video in which the actor communicates an opener message based on that learned or previous interaction may be stored in opener videos storage device 730.

In some embodiments, processor 724 which may be the same or similar as processing circuitry 306 may monitor the simulated dialog on media equipment device 720. Processor 724 may automatically detect, from the verbal communication of the user, people, places and things and determine whether the user likes or dislikes the people, places and things that are discussed in the verbal communication. Processor 724 may store to memory 726 in a profile for the user the people, places and things along with whether the user likes or dislikes those people, places and things. Processor 724 may transmit a communication to media server 710 with the people, places and things that the user likes or dislikes. Microprocessor 714 may determine whether any videos on storage devices 730, 732 or 734 include messages communicated by a selected actor in which the actor discusses the people, places or things that the user likes or dislikes. When such a video of the actor exists or is identified in media server 710, microprocessor 714 may provide that video or collection of videos of the actor to media equipment device 720 for display during the current or subsequent simulated dialogs with the user.

In some embodiments, when the video of the actor that is identified in media server 710 is an opener, media equipment device 720 may display that video at the start of the next dialog with the user. When the video of the actor that is identified in media server 710 is a banter video, media equipment device 720 may display that video at a point in the middle of the simulated dialog with the user. When the video of the actor that is identified in media server 710 is a closer video, media equipment device 720 may display that video at a point in the end of the simulated dialog with the user.

Closer videos storage device 732 may include videos of one or more actors in which the one or more actors communicate a closer message. Each actor may have a multiple different types of closer message videos stored in closer videos storage device 732. In particular, having multiple different types of closer message videos of the actor allows media equipment device 720 to present different closing dialog videos to the user to avoid repetition.

For example, when the user first has a conversation with actress Meredith Vieira, a first closer video of that actress may be presented to the user in which the closer message may be “It was great spending time with you, let's do this again tomorrow!” When the user previously had a conversation with actress Meredith Vieira, a second closer video of that actress may be presented to the user in which the closer message may be “It's great we had this chance to chat, see ya soon!”; “I won't take more of your time; have a great “Today!”—note that in the second closer message, the actress made a play on words to end the dialog on a positive note and remind the user to access the media asset associated with the actress; or “Time for me to go, I have to start contributing to tomorrow's “Today” show. I hope to see you again then.”

Banter videos storage device 734 may include videos of one or more actors in which the one or more actors communicate a banter message. Banter messages may include ploys that are presented when verbal input received from the user is unexpected or includes uncertainty. Ploys are discussed in more detail below in connection with media equipment device 720. Each actor may have a multiple different types of banter message videos stored in banter videos storage device 734. In particular, having multiple different types of banter message videos of the actor allows media equipment device 720 to present different banter dialog videos to the user to avoid repetition.

Media asset clips storage device 740 may include clips of media assets associated with actors for which videos may be stored in storage devices 730, 732 and 734. For example, actress Meredith Vieira may be associated with the media asset “Today Show”. Accordingly, for the actress Meredith Vieira, media asset clips storage device 740 may include selected portions (e.g., 5-10 minute or second segments) of one instance (e.g., most recently broadcast instance) of the “Today Show” media asset and/or other instances (e.g., previously broadcast instances) of the “Today Show” media asset. Similarly, if the actress Meredith Vieira is associated with other media assets in addition to the “Today Show” media asset, clips of those media assets may also be stored in media asset clips storage device 740.

In some embodiments, the media asset with which the actor is associated may be a short video segment or photograph of the actor. In such circumstances, the clips stored in media asset clips storage device 740 may be the short video segments or photographs in their entirety. For example, an actor may be tagged or associated on the Internet (e.g., through a website www.TMZ.com) with photographs or short video segments that show the personal life of the actor. These short video segments or photographs may be compiled and stored to media asset clips storage device 740 for the actor to present to the user during the course of a dialog simulation where the actor for example asks the user whether the user would like to see personal videos or photographs of the actor.

Media equipment device 720 may include a memory 726, a display screen 729, a processor 724, an input device 728, a voice processing circuit 750 and a microphone 760. Microphone 760 may be any type of device capable of receiving audio input from the user. In some aspects, media equipment device 720 may allow the user to have a simulated dialog with an actor that the user may select. In particular, processor 724 may display on display screen 729 a main menu as shown in screen 500 (FIG. 5). Upon receiving a user selection, through input device 728, of one or more actors with which the user would like to have a dialog, processor 724 may determine whether videos of the selected actor are stored in memory 726. In some implementations, processor 724 may monitor microphone 760 to determine whether the user verbally indicated an interest in speaking or having a dialog with a particular actor. Processor 724 may automatically processor that verbal response and retrieve for display an opener video of the verbally selected actor.

For example, processor 724 may determine whether an opener video of the selected actor is stored in memory 726. When an opener video of the selected actor is stored in memory 726, processor 724 may retrieve the stored opener video and display the opener video for the user. In some implementations, processor 724 may analyze a data structure associated with the user or opener video to determine whether the user has previously seen the opener video. When the opener video is not stored in memory 726 or when the user has seen the opener video of the actor stored in memory 726, processor 724 may transmit a communication through communication circuit 722 to media server 710 to retrieve an opener video of the actor.

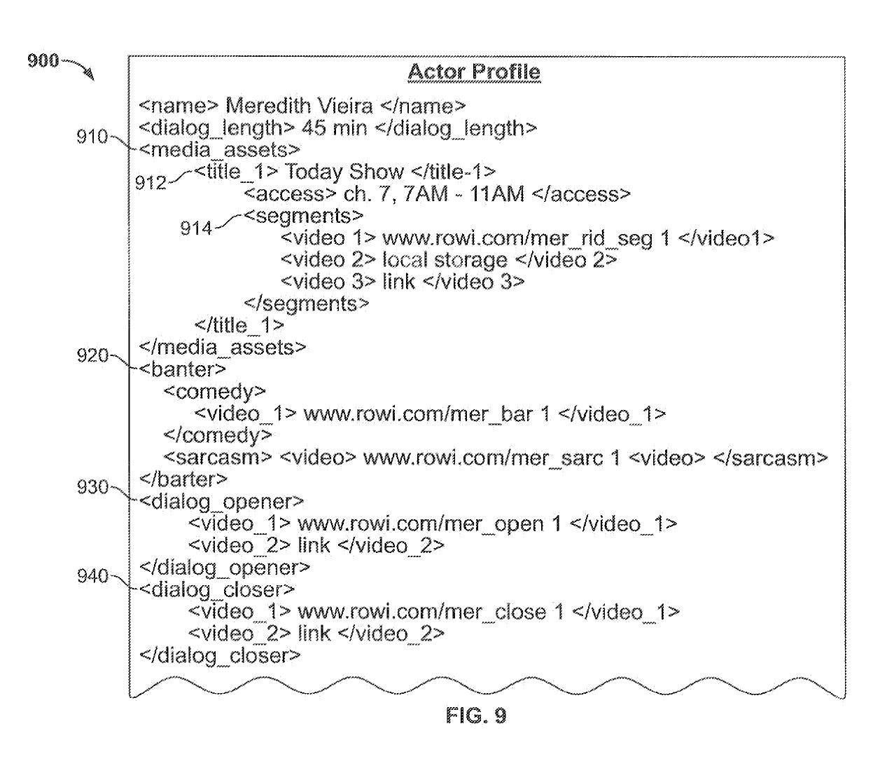

In some embodiments, processor 724 may retrieve an actor profile 900 (FIG. 9) corresponding to the selected actor. Actor profile 900 may include fields which allow processor 724 to determine storage locations of videos of the actor and/or media asset clips associated with the actor. For example, actor profile 900 may include a dialog opener field 930 which may direct processor 724 to the storage location of one or more videos of the actor in which the actor communicates a dialog opener. Similarly, actor profile 900 may include a dialog closer field 940 which may direct processor 724 to the storage location of one or more videos of the actor in which the actor communicates a dialog closer. In particular, processor 724 may access a website provided in fields 930 or 940 where the videos of the actor are stored.

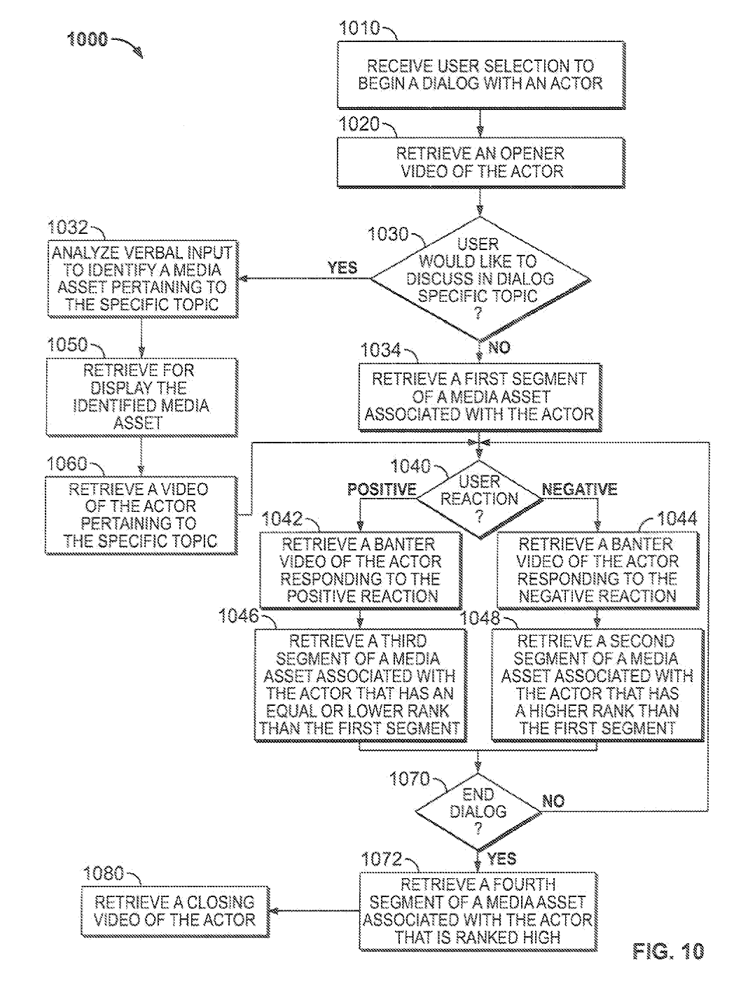

In some implementations, processor 724 may retrieve from media server 710 all available videos of the selected actor that are not stored in memory 726. In particular, processor 724 may retrieve from media server 710 all opener, closer and banter videos of the one or more actors selected in, for example, screen 500 (FIG. 5). After an opener video of the selected actor is displayed for the user, processor 724 may monitor microphone 760 for any verbal response the user provides. In general, the dialog simulation between the actor and the user may be provided in a sequence that mirrors a typical conversation. For example, the dialog simulation may begin with an opener video of the selected actor followed by a verbal response from the user. The verbal response received from the user may either cause a banter video of the actor to be retrieved for display or a media asset clip (having a certain rank) associated with the actor to be retrieved and displayed. Verbal response of the user may be monitored and may cause another banter video of the actor to be retrieved for display or another media asset clip (having a certain rank) associated with the actor to be retrieved and displayed. Finally, after a certain amount of time or after the user has been exposed to a certain number of media asset clips, a media asset clip having a high ranking associated with the actor may be retrieved for display and followed by a closer video of the actor. The process of simulating a dialog between the actor and the user is discussed in greater detail below in connection with FIG. 10.

During the course of the dialog simulation uncertainties associated with the verbal response of the user may be determined and handled with one or more ploys. More specifically, the verbal response received through microphone 760 may be processed by voice processing circuitry 750 to extract or determine the utterances in the verbal input. In particular, voice processing circuitry 750 may perform a digital/analog processing algorithm to provide voice recognition for the received verbal input. Voice processing circuitry 750 may perform voice recognition with some uncertainty. In particular, voice processing circuitry 750 process utterances received through microphone 760. For example, when the user verbally responds with “no, sorry I missed it” to an opener video that asks the user whether the user has seen a media asset associated with the actor, the five utterances that are detected may be “no-sor-ry-missed-it”. These five utterances may be processed to determine the meaning which leads to some uncertainty.

Uncertainties may be handled using actor banter videos that include ploys. These uncertainties may be handled at any point in the dialog with a ploy type actor video. When voice processing circuitry 750 associates the received utterances with an expected value, voice processing circuitry 750 may instruct processor 724 to retrieve a media asset clip or actor video corresponding to the received response. For example, voice processing circuitry 750 may expect a yes or no response which may be easily identified in the received utterances. A video associated with each yea and no response may be identified and retrieved for display. In some embodiments, processor 724 may determine and retrieve the storage location of banter videos of the actor in which the message includes a ploy from a banter field 920 in actor profile 900 (FIG. 9).

Voice processing circuitry 750 may generate an interrupt indicating to processor 724 that an unacceptable uncertainty was detected in the received verbal input. In particular, voice processing circuitry 750 may generate such an interrupt when the received verbal input does not match any expected values. Processor 724 may receive the interrupt from voice processing circuitry 750 may determine how to handle the unacceptable uncertainty. Any one of several techniques may be employed by processor 724 to handle the uncertainty. For example, the unacceptable uncertainty may be handled by creating a conflict, ignoring the received verbal response, retrieve a video associated with an expected response, provide a delay, retrieve a video that has content related to some portion of the received response that was properly identified, or any other suitable technique. Processor 724 may select the technique to employ to handle the unacceptable uncertainty at random, sequentially in a circular loop, or in any other suitable manner.

In some implementations, a conflict may be created to handle unacceptable uncertainty in the verbal response received from the user. For example, processor 724 may retrieve a banter type video of the actor in which the actor communicates a conflict message that changes the subject to something distracting or controversial. This may cause the user to provide another verbal response to the new video of the actor providing the conflict message which may then be processed by media equipment device 720 to determine what the next video of the actor or media asset clip to retrieve for display. In particular, the conflict message communicated by the actor in the banter video may be “Oh! I was just reviewing our piece from this morning, ‘The biggest sex organ, your brain.’ Would you like to look at that together?” Note that the message provides an interesting tie into another subject to which the user may respond with a yes or no which may be processed with less uncertainty. Such a ploy may keep the simulated dialog fun and interesting with seamless transitions even when uncertainty is determined in the verbal response received from the user. When the user responds with a yes, processor 724 may retrieve a clip of the media asset associated with the subject in the conflict message (e.g., a media asset clip of the show discussing the brain). For example, processor 724 may determine and retrieve from the storage location identified by fields 912 and 914 of actor profile 900 (FIG. 9) one or more media asset clips associated with the actor.

In some implementations, unacceptable uncertainty may be handled by ignoring the received verbal response. In particular, processor 724 may retrieve a banter type video of the actor in which the actor communicates a message about a specific attribute associated with the user. For example, processor 724 may retrieve a profile associated with the user to identify a specific attribute associated with the user such as an ethnicity of the user, a location of the user, the gender of the user, a favorite person, actor, celebrity or media asset of the user, or any other suitable specific attribute. In some implementations, processor 724 may identify locally in memory 726 or in storage on media server 710 a video of the actor in which the actor communicates a message based on the identified specific attribute associated with the user. For example, the message communicated by the actor in the identified video for a user located in Southern California may be “You're in Southern California, we had a piece today about getting prescription drugs in Hollywood.” Such a message provides the user with useful information about the user based on the attribute associated with the user and allows the user to respond in a way that instructs the system to retrieve a media asset clip based on the specific attribute (e.g., the media asset clip of the show discussing the prescription drugs in the location of the user). The message may alternatively provide the user with popular topics or information (e.g., recent wedding or divorce) about a particular celebrity in which the user has an interest. In some implementations, processor 724 may identify locally in memory 726 or in storage on media server 710 a media asset clip corresponding to the identified specific attribute associated with the user.

In some implementations, unacceptable uncertainty may be handled by retrieving a video associated with an expected response. In particular, processor 724 may proceed based on an expected response (e.g., Yes or No) regardless of the content in the actual response received. For example, the unacceptable expected response may have been a Yes or No answer but instead the user responded with “I don't care” which does not match either expectation. Processor 724 may proceed as if the user responded with Yes and retrieve a video of the actor or media asset clip based on the expected response. For example, processor 724 may assume the answer was Yes for the question in the communicated message from the actor asking if the user has seen a particular media asset. Accordingly, processor 724 may retrieve a video of the actor in which the message communicated by the actor is “Is there something in particular you would like to talk about?” Note that even though processor 724 randomly selected the Yes expected response, it appears to the user as if processor 724 correctly processed the actual response of “I don't care” as the message applies to both responses (e.g., actual and expected responses) and the simulated dialog proceeds in a seamless manner.

In some implementations, unacceptable uncertainty may be handled by providing a delay. In particular, processor 724 may retrieve a video of the actor in which the actor appears to pretend to listen by leaning closer to the user or communicates a message such as “Ah-huh. Really?” seeming interested in what the user has to say. This may create sufficient delay for the user to repeat or rephrase the previous response allowing media equipment device 720 to process the new response.

In some implementations, unacceptable uncertainty may be handled by retrieving a video or media asset clip that has content related to some portion of the received response that was properly identified. In particular, voice processing circuitry 750 may indicate to processor 724 that an unacceptable uncertainty was detected because some parts of the verbal response was recognized as matching an expected or known word or phrase but other parts of the verbal response were not. Voice processing circuitry 750 may provide the recognized word or phrase to processor 724 and processor 724 may in response automatically identify media asset clips or videos of the actor either locally or on media server 710 that are associated with the recognized word or phrase. For example, voice processing circuitry 750 may identify a phrase “Middle East” which is present in the verbal response the user provides of “What's happening in the Middle East?” Processor 724 may as a result, retrieve a video of the actor in which the actor communicates a message asking “How do you feel about the conflict there? implying the conflict in the Middle East (e.g., the identified phrase in the verbal response).

The banter videos of the actor provided in the ploys discussed above may be reused in response to many questions or verbal responses provided by the user. The ploys in the banter videos of the actor may be provided to get the user to talk about themselves and continuously retrieve videos or media asset clips based on parts of the verbal responses that are identified and that are associated with particular videos of the actor or media asset clips.

In some embodiments, the length of time of the simulated dialog is determined based on the reactions of the user to the simulated dialog. In particular, processor 724 may monitor the reactions of the user to the videos of the actor and/or media asset clips that are displayed (as discussed in more detail below) to determine whether the reactions are positive or negative. When the reactions are determined to be positive, processor 724 may continue to provide banter videos of the actor and/or media asset clips associated with the actor to the user which causes the simulated dialog to last a longer period of time. Alternatively, as reactions tend to be determined to be negative, processor 724 may retrieve closer videos of the actor to end the simulated dialog earlier.

In some aspects, media equipment device 720 may provide video clips to the user based on the reaction of the user to the displayed clips. For example, media asset clips may be stored in media asset clip storage device 740 on media server 710. Each media asset clip may be associated with a rank relative to other media asset clips that are stored. The rank may be assigned by a person (e.g., an expert in assigning ranks) or automatically by monitoring which media asset clips have the most positive reactions in a community of users or are accessed a greater number of times within a particular time frame by a community of users. For example, media asset clips that are accessed a greater number of times than other media asset clips may be associated with higher ranks. The ranks may be separated into three classes, high level, mid level and low level ranks. Media asset clips associated with a rank valued within a certain threshold are assigned to a same class. In general, all media asset clips in the high level class are associated with ranks greater than media asset clips in the mid level class and all media asset clips in the mid level class are associated with ranks greater than media asset clips in the low level class.

Media equipment device 720 may retrieve a plurality of media asset clips that are associated with an actor selected by the user or that match a preference of the user from media server 710. Media equipment device 720 may retrieve a plurality of media asset clips from each level class (e.g., two media asset clips from the high level, two from the mid level and two from the low level). Media equipment device 720 may first display a media asset clip from the mid level class to the user.

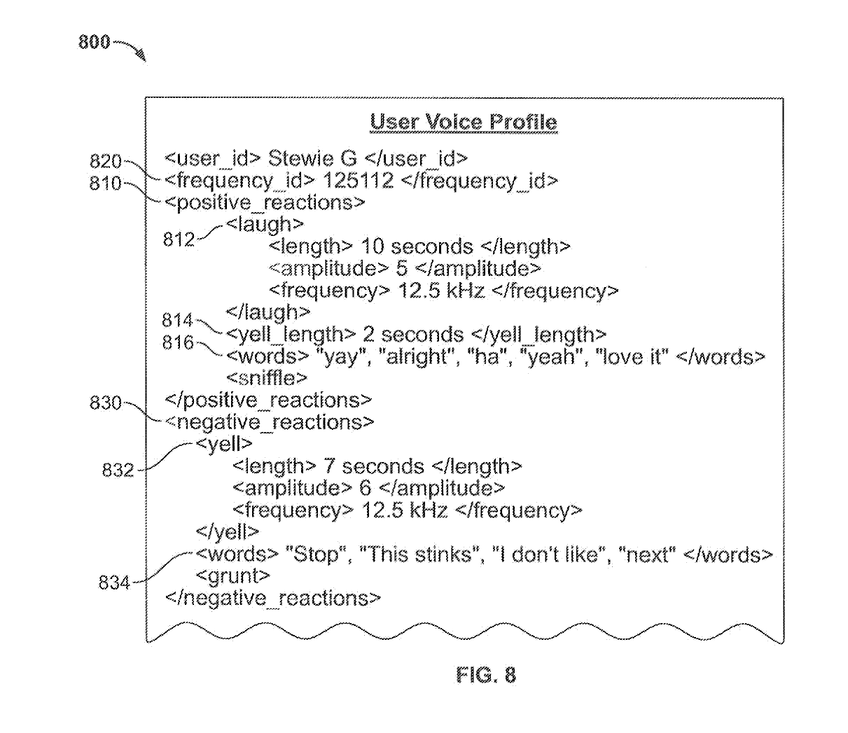

Microphone 760 may monitor verbal responses from the user as the user is exposed to the displayed media asset clip. Voice processing circuitry 750 may process the verbal responses as the user is exposed to the media asset clip to determine whether the reactions of the user are positive or negative. For example, voice processing circuitry 750 may compare characteristics of the verbal responses to characteristics stored in a user voice profile 800 (FIG. 8) associated with the user to determine whether the characteristics of the verbal responses match positive or negative characteristics stored in a user voice profile 800. In particular, user voice profile 800 may have positive reactions field 810 in which characteristics of positive verbal responses may be stored. In some implementations, processor 724 may determine that the user is reacting negatively to the displayed video or media asset clip by detecting the absence of laughs, coughs or other non-language utterances during the display of the video or media asset clip or during specific times of the media asset clips of videos at which a laugh or certain reaction is expected. For example, when the media asset clip includes a joke provided 5 seconds into the display of the media asset clip, processor 724 may detect the absence of a laugh when the joke is provided and determine the reaction of the user to the media asset clip to be negative.

For example, a laugh field 812 of positive reactions field 810 may indicate the length, amplitude and frequency of the verbal responses of the user when the user is laughing or reacting positively to what the user is exposed to. Certain phrases or words that may be recognized by voice processing circuitry 750 may be stored to user voice profile 800 in field 816. Similarly, negative reactions field 830 may include characteristics field 832 and words field 832 which indicate the user reactions to be negative. When the detected or monitored reactions match positive characteristics field 810, voice processing circuitry 750 may indicate to processor 724 that the user is reacting positively to the media asset clip that the user is exposed to. Similarly, when the detected or monitored reactions match negative characteristics field 830, voice processing circuitry 750 may indicate to processor 724 that the user is reacting negatively to the media asset clip that the user is exposed to.

In some embodiments, user voice profile 800 may be automatically generated by training media equipment device 720 with how the user reacts to certain clips. For example, media equipment device 720 may be entered into training mode. Media equipment device 720 may retrieve for display a media asset clip that is ranked amongst the lowest media asset clips. Alternatively, media equipment device 720 may retrieve for display a specially prepared media asset clip that is made to incite a positive reaction such as a funny cartoon skit. Media equipment device 720 may monitor the user reactions (e.g., a laugh reaction or words spoken) and may store characteristics of the reactions to positive reactions field 810. Similarly, media equipment device 720 may retrieve for display a media asset clip that is ranked amongst the highest media asset clips. Alternatively, media equipment device 720 may retrieve for display a specially prepared media asset clip that is made to incite a negative reaction such as a disturbing image or video. Media equipment device 720 may monitor the user reactions (e.g., a yelling reaction or words spoken) and may store characteristics of the reactions to negative reactions field 830. The user may also manually enter words or phrases that the user says that are associated with positive or negative reactions into user voice profile 800.

Based on the monitored reactions of the user, media equipment device 720 may retrieve another media asset clip for display. In particular, when the monitored reactions of the user are determined to be negative, processor 724 may retrieve a media asset clip that belongs to the high level class (e.g., a media asset clip that belongs to a class level greater than the media asset clip to which the user was last exposed). Alternatively, when the monitored reactions of the user are determined to be positive, processor 724 may retrieve a media asset clip that belongs to the low level class (e.g., a media asset clip that belongs to a class level lower than the media asset clip to which the user was last exposed). Reactions of the user may again be monitored and the next media asset clip may be retrieved for display based on the monitored reactions.

In some implementations, when a media asset clip that belongs to the high level class is displayed and the reactions of the user are determined to be negative, a media asset clip within the high level class that is ranked higher within the high level class than the previously provided media asset clip may be retrieved for display. Similarly, when a media asset clip that belongs to the low level class is displayed and the reactions of the user are determined to be positive, a media asset clip within the low level class that is ranked lower within the low level class than the previously provided media asset clip may be retrieved for display. In some implementations, when a media asset clip that belongs to the high level class is displayed and the reactions of the user are determined to be negative or when a media asset clip that belongs to the low level class is displayed and the reactions of the user are determined to be positive, the next media asset clip may be randomly retrieved for display. In some implementations, the last media asset clip that is displayed may belong to the high level class. The process of providing media asset clips to the user based on the reactions of the user is discussed in greater detail below in connection with FIG. 12.

It should be understood, that teachings associated with one aspect of media equipment device 720 may be combined with teachings associated with any another aspect of media equipment device 720 in a suitable manner.

In some embodiments, videos of the selected actor that are displayed in a particular simulated dialog or during a particular time frame (e.g., during the same day) may be processed to maintain continuity throughout the dialog or time frame. The videos may be processed by processing circuitry 306 (FIG. 3). The videos may be processed in media server 710, media equipment device 720 or both (FIG. 7). In particular, videos of the actor that are displayed in a particular simulated dialog or time frame may be processed to avoid the appearance of jumps between a first video of the actor (e.g., an opener video) and a subsequent second video of the actor (e.g., a banter video). For example, a set of opener videos of the actor may be filmed on one occasion and a set of banter videos of the actor may be filmed on a second separate occasion (e.g., a different day) during which the actor may have a different visual appearance (e.g., different clothing, makeup, hairstyle, etc.). Thus, without processing the videos of the actor for continuity, the end user during the course of the simulated dialog may see the actor in different visual appearances which may be distracting for the user. This may even cause a lapse in the user's suspension of disbelief.

In some implementations, videos of the actor may be processed to maintain continuity of the visual appearance of the actor. For example, the actor may be filmed (during production) against a blue/green screen background and be provided with a blue/green outfit, makeup, hairspray, etc. so that the background and the outfit, makeup, hairspray, etc. can be added into the video during post-production processing. In particular, green/blue screens are commonly used for weather forecast broadcasts, where the presenter appears to be standing in front of a large map, but in the studio (where the filming takes place) it is actually a large blue or green background. The meteorologist stands in front of a blue screen, and then different weather maps are added on those parts in the image where the color is blue. If the meteorologist himself wears blue clothes, his clothes will become replaced with the background video. Green screens may also be used, since blue and green may be the colors least like skin tone. Accordingly, the actor may be filmed using the green/blue screen technique and the video may be processed to maintain continuity among a set of videos of the actor.

In some implementations, a first video of the actor may be presented to the user to start a dialog and after the user provides a verbal response, a second video of the actor may be presented without having the appearance of any jumps between the first and second videos. In particular, because the first and second videos of the actor may have been filmed on different occasions the positioning and demeanor of the actor in the first and second videos may be different. Accordingly, the first and second videos may be processed prior to being displayed to prevent the appearance of the actor jumping from between the different positions and demeanor. For example, a few video frames may be morphed (added) between the presentation of the first and second videos to smoothly transition one segment (e.g., the first video where the actor is in one position and demeanor) to a second segment (e.g., the second video where the actor is in a different position and demeanor).

In some implementations, videos of the actor may be processed to maintain continuity of the audio provided by the actor and the studio in which the actor was filmed. For example, the actor may be filmed to create a first video on one day and may be filmed to create a second video (which may be displayed during the same simulated dialog with the user at a later time). In creating the second video, the actor may have a different speech or voice (e.g., because of a cold or other issue) which may lead to discontinuity in audio that is heard between the presentation of the first and second videos. Accordingly, the first and second videos may be processed to normalize the audio from various sessions by post-production audio filtering. In particular, the voice of the actor provided in the audio of the first video may be extracted and compared against the voice of the actor provided in the audio of the second video. Processing circuitry 306 may filter and modify the audio in the second video to match, within a predetermined threshold (e.g., 15%), the audio in the first video.

FIG. 10 is illustrative flow diagram 1000 for providing dialog simulation with an actor in accordance with embodiments of the present invention. At step 1010, a user selection to being a dialog with an actor is received. For example, the user may select one or more actors from actor listings 540 and select start dialog option 538 to start the simulated dialog with the selected actors (FIG. 5). In some embodiments, the user may speak the name or names of the actors with whom the user would like to start a dialog and processing circuitry 306 may perform voice recognition to automatically identify and start a dialog with the voice selected actor.

At step 1020, an opener video of the actor is retrieved. For example, an opener video that the user has not been exposed to may be retrieved from memory 726 or opener video storage device 730 (FIG. 7). In particular, processing circuitry 306 may determine whether the user has previously had a conversation with the selected actor and retrieve a video of the selected actor with an opening based on that determination. For example, first media 610 may be retrieved for inclusion in a display sequence (FIG. 6).

At step 1030, a determination is made as to whether the user would like to discuss a specific topic in the dialog with the actor. For example, the opener video may include a message communicated by the actor asking the user how they are feeling or what the user would like to talk about. Verbal response of the user may be analyzed with voice recognition to determine whether the user would like to talk about something specific or whether the user is indifferent. When the user would like to discuss a specific topic, the process proceeds to step 1032, otherwise the process proceeds to step 1034. For example, the determination may cause processor 306 to add video or clips as first plurality of media 630 or playback second media 612 (FIG. 6).

In some embodiments, the user may input a command by selecting an option on the display screen indicating the desire to discuss a certain topic. For example, a plurality of topics associated with the actor that are available for discussion may be displayed on the screen. The user may select a particular topic by verbally speaking the topic that is displayed or selecting the topic with a navigable highlight region. Processing circuitry 306 may retrieve a banter video of the actor associated with the selected topic for display.

At step 1032, verbal input received from the user is analyzed to identify a media asset pertaining to the specific topic. For example, voice processing circuit 750 may receive the analog verbal input from microphone 760 and convert the analog input to digital form for processing (FIG. 7). Voice processing circuit 750 may identify directly from the analog input or the digitized verbal input whether the input matches any locally stored keywords or remotely stored keywords. When the verbal input matches one or more keywords, voice processing circuit 750 may indicate to processor 724 the matching keywords. Processor 724 may identify or determine which media asset are associated with the matching keywords or may request media server 710 to make the determination of which media asset is associated with the matching keywords. For example, the keywords “middle east” may be determined to match the verbal input. The selected actor may be associated with the media asset “Today Show” and a segment of that media asset may be about the war in the Middle East. Accordingly, processor 724 may determine that the segment of the media asset associated with the actor and the verbal input may be the segment about the Middle East war. For example, second media 612 may be determined and selected as the media asset that pertains to the user selected topic.

At step 1050, the identified media asset is retrieved for display. Processor 724 may retrieve the identified segment from memory 726 or from media asset clips 740.

At step 1060, a video of the actor pertaining to the specific topic is retrieved. For example, a banter video may be retrieved from banter video storage device 734 of the selected actor. In particular, the banter video of the actor may have a message communicated by the actor talking about the segment that was presented to the user. The process then proceeds to step 1040. For example, one of second plurality of media 632 that follows immediately second media 612 may be a video of the actor in which the message communicated by the actor is banter type (FIG. 6).

At step 1034, a first segment of a media asset associated with the actor is retrieved. For example, segments of a media asset associated with the actor may be stored in media asset clips storage device 740 and may be associated with different ranks and/or class levels (e.g., high, middle, low). A first segment associated with a middle class level may be retrieved after the opener video of the actor is displayed. The first segment may pertain to a recent broadcast of the media asset associated with the actor which the user has missed or not recorded.

At step 1040, a user reaction to the displayed video is monitored. For example, voice processing circuit 750 may compare verbal utterances the user makes that are detected by microphone 760 to utterances stored in a user voice profile 800 associated with the user. Voice processing circuit 750 may indicate to processor 724 whether the utterances are associated with positive or negative reactions. When the user reaction is determined to be positive, the process proceeds to step 1042, otherwise the process proceeds to step 1044.

At step 1042, a banter video of the actor is retrieved in which the actor communicates a message responding to the positive reaction. For example, a banter video of the actor may be retrieved from banter videos storage device 734 in which the actor communicates a message stating “I knew you would like that segment, wait till you see what else I have in store for you.” For example, one of second plurality of media 632 that follows immediately second media 612 may be a video of the actor in which the message communicated by the actor is banter type (FIG. 6).

At step 1046, a third segment of the media asset associated with the actor is retrieved, where the third segment is associated with a rank having equal or lower value than a rank associated with the first segment. For example, when the first segment is retrieved from the middle class level, the third segment may be retrieved from the low class level clips of the media asset. The process then proceeds to step 1070. For example, a second one of second plurality of media 632 may be the third segment of the media asset associated with the actor that has a rank having equal or lower value than the rank associated with the first segment (FIG. 6).

At step 1044, a banter video of the actor is retrieved in which the actor communicates a message responding to the negative reaction. For example, a banter video of the actor may be retrieved from banter videos storage device 734 in which the actor communicates a message stating “I was uncertain whether you would like that but you should enjoy this next one a little more.”

In some embodiments, a short commercial break may be provided between segments or videos that are displayed for the user. In some implementations, advertisements may be provided with the videos or segments that are displayed. In some implementations, advertisements may be included in the communicated messages that are provided by the actor. For example, the actor may communicate a message in a banter video which states “Before I show you the behind the scenes footage of the ‘Today Show’, I wanted to introduce you to the hand cream product I started using last week that works great. Here take a look” and proceed to display the product in the banter video.

At step 1048, a second segment of the media asset associated with the actor is retrieved, where the second segment is associated with a higher rank than a rank associated with the first segment. For example, when the first segment is retrieved from the middle class level, the third segment may be retrieved from the high class level clips of the media asset.

At step 1070, a determination is made as to whether to end the simulated dialog. For example, processing circuitry 306 may determine to end the simulated dialog after a predetermined time period has elapsed (e.g., 30 minutes) or when the user indicates a desire to stop talking or turns OFF the system. Alternatively, processing circuitry 306 may determine to end the conversation when a predetermined number of reactions of the user are determined to be negative (e.g., more than 4 consecutive negative reactions are determined). When the simulated dialog is determined to end, the process proceeds to step 1072, otherwise the process proceeds to step 1040.

At step 1072, a fourth segment of a media asset associated with the actor is retrieved, where the fourth segment is associated with a rank higher than a rank associated with a set of segments. For example, the fourth segment may be retrieved from the high class level clips of the media asset and may be a segment that is ranked among the highest within the high class level.

At step 1080, a closing video of the actor is retrieved for display. For example, processor 724 may retrieve a closing video of the actor from memory 726 or closer videos storage device 732 (FIG. 7). In some embodiments, the closing video may be selected among a plurality of closing videos of the actor for retrieval in a random manner. In some implementations, the random retrieval of the closing video may be weighted such that some videos are more likely to be randomly selected than others. Any of the retrieval of videos or clips (e.g., banter video retrieval, media asset clip retrieval, and/or opener video retrieval) techniques discussed above and below may be performed in a weighted random manner making one set of videos or clips more likely to be selected for retrieval than others. In some embodiments, the weights assigned to the videos or clips that are used in performing the weighted random selection may be modified/changed dynamically in real-time based on verbal responses and/or interactions made between the user and media equipment device 720 during a simulated dialog session. For example, third media 614 may be a video of the actor in which the message communicated by the actor includes a closer which ends the dialog (FIG. 6).

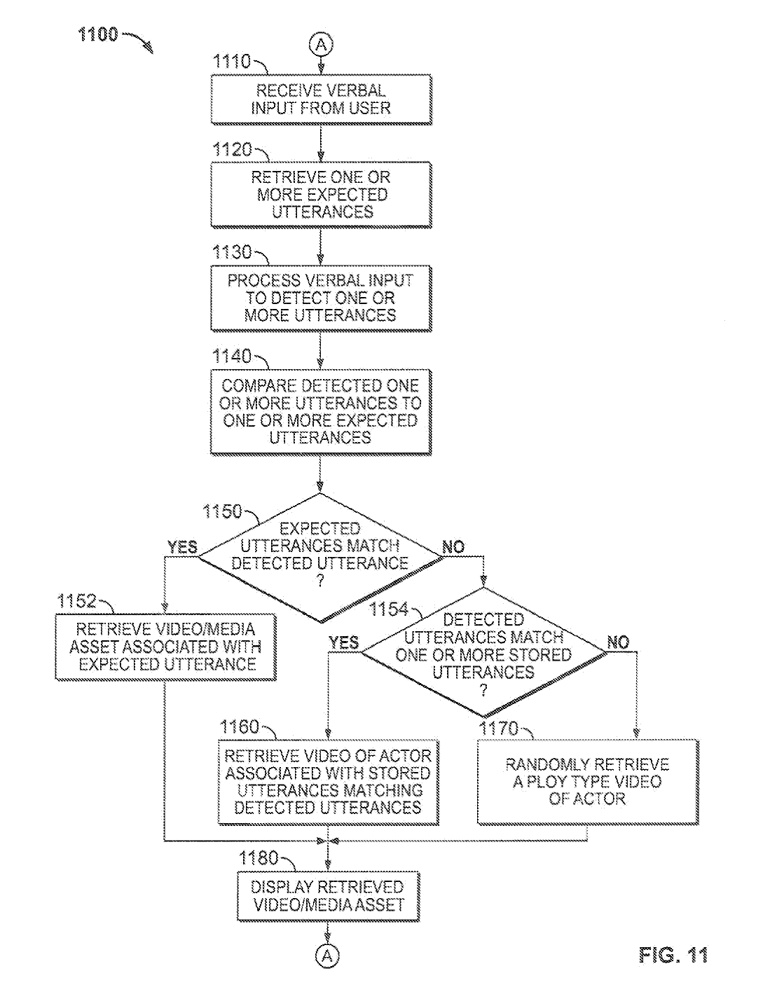

FIG. 11 is illustrative flow diagram 1100 for providing dialog simulation with an actor in accordance with embodiments of the present invention. At step 1110, verbal input is received from a user. For example, microphone 760 may detect verbal input, buffer the received input in a memory and provide the buffered input to voice processing circuit 750 (FIG. 7).

At step 1120, one or more expected utterances are retrieved. For example, processor 724 may determine using a database or look-up table, one or more expected utterances associated with a video or media asset that is being provided to the user and retrieve the determined one or more expected utterances. In particular, a video of an actor may be displayed in which the actor communicates a message asking the user how the user is feeling. The expected utterances associated with that video may include utterances corresponding to the words “good, bad, need a break, wonderful, and sick.”

At step 1130, the verbal input is processed to detect one or more utterances. For example, voice processing circuit 750 may perform a voice recognition algorithm and may use a locally stored user voice profile 800 to convert the received verbal response to detected one or more utterances.

At step 1140, the detected one or more utterances are compared with the one or more expected utterances. For example, processor 724 may compare whether the detected one or more utterances match the expected utterances associated with the video or media asset provided to the user.

At step 1150, a determination is made as to whether the expected utterances match the detected utterance. When the expected utterances match the detected utterances, the process proceeds to step 1152, otherwise the process proceeds to step 1154.

At step 1152, a video or media asset associated with the expected utterance is retrieved for display. For example, processor 724 may determine that the detected utterance matches an expected utterance corresponding to the word “good” and accordingly may retrieve a video of the actor in which the actor communicates a message stating “I feel great too, let me show you something that will make you feel even better.” The process then proceeds to step 1180.

At step 1154, a determination is made as to whether the detected utterances match one or more stored utterances. For example, processor 724 may provide the detected utterances to media server 710 to identify any utterances associated with media asset clips stored in storage device 740 or videos of the selected actor stored in storage devices 730, 732 and 734 that match the detected utterances. When the detected utterances match one or more stored utterances, the process proceeds to step 1160, otherwise the process proceeds to step 1170.

At step 1160, a video of an actor associated with the stored utterances matching the detected utterances is retrieved. For example, processor 714 may retrieve a video of the actor or clip of a media asset stored in storage devices 730, 732, 734 or 740 that is associated with the utterance that is stored that matches the detected utterance. The process then proceeds to step 1180.

At step 1170, a ploy type video of the actor is randomly retrieved. For example, processor 724 may determine that the verbal input received from the user exceeds a level of uncertainty as no matching videos or media assets are associated with the received verbal input and may as a result retrieve a banter video of the selected actor which is associated with a ploy. In particular, processor 724 may retrieve a video of the actor in which the actor communicates a message that changes the topic of discussion.

At step 1180, the retrieved video or media asset is displayed. For example, processor 714 may provide the retrieve video or media asset to media equipment device 720 for provision to the user through display 729. The process then proceeds to step 1110.

FIG. 12 is an illustrative flow diagram 1200 for providing media asset clips based on user reactions in accordance with embodiments of the present invention. At step 1210, a media asset that matches preferences associated with a user is identified. For example, processing circuitry 306 may receive a user selection of a particular media asset (e.g., Family Guy) or identify a media asset that matches preferences stored in a user preference profile (e.g., a media asset that matches a comedy genre stored in the preference profile).

At step 1220, a clip of the media asset having a rank between highest ranked clips of the media asset and lowest ranked clips of the media asset is retrieved. Processing circuitry 306 may retrieve from media server 710 a plurality of clips that includes clips associated with at least three different class level ranks (e.g., high class level, mid class level and low class level). Processing circuitry 306 may display for the user one of the clips associated with a mid class level rank (e.g., a clip associated with a rank between the high class level ranks and low class level ranks).

In some embodiments, when a clip is displayed, the user may be provided with an option to access the full episode of the media asset corresponding to the displayed clip. For example, when a 2-3 minute clip of episode number 43 of the media asset “Family Guy” is presented for the user, processing circuitry 306 may receive a user selection instructing processing circuitry 306 to retrieve the full length episode number 43 of the media asset “Family Guy”. In some implementations, the user may be required to provide payment information before being allowed to access the requested episode of the media asset.

At step 1230, verbal reactions of the user to the display of the retrieved clip are monitored. For example, microphone 760 may receive and store audio made by the user in a buffer. In some implementations, microphone 760 may filter out of the received audio frequencies that are outside of a frequency range associated with a particular user which may be stored in a user voice profile 800 (FIG. 8). Filtering out the audio frequencies may enable media equipment device 720 to monitor reactions made by a specific user and exclude any noise or reactions made by other users that may be within the vicinity of media equipment device 720. It should be understood that such filtering techniques may be used in conjunction with any other embodiment discussed above and below in which a verbal input is received and processed allowing the system to respond only to a particular user and/or to identify a given user based on the voice frequency associated with the user.

At step 1240, the monitored reactions of the user are compared with stored reactions associated with the user. For example, voice processing circuit 750 may compare verbal utterances the user makes that are detected by microphone 760 to utterances stored in a user voice profile 800 associated with the user (FIGS. 6 and 7). Voice processing circuit 750 may indicate to processor 724 whether the utterances are associated with positive or negative reactions.

At step 1250, the type of reaction of the user is determined. For example, processor 724 may determine based on information processor 724 receives from voice processing circuit 750 whether the type of reaction is positive or negative. When the type of reaction is positive, the process proceeds to step 1252, otherwise the process proceeds to step 1254.

At step 1252, a clip of the media asset ranked lower than the rank of the previously displayed clip is retrieved. For example, processor 724 may retrieve, from memory 726 and/or from media server 710, a clip of the media asset (e.g., a 5 minute segment of the media asset “Family Guy”) which is associated with a low class level rank. The process then proceeds to step 1260.

At step 1254, a clip of the media asset ranked higher than the rank of the previously displayed clip is retrieved. For example, processor 724 may retrieve, from memory 726 and/or from media server 710, a clip of the media asset (e.g., a 5 minute segment of the media asset “Family Guy”) which is associated with a high class level rank. In some embodiments, commercial breaks or advertisements may be provided between each of the clips that are retrieved and displayed.

At step 1260, a determination is made as to whether a maximum number of retrieved clips has been reached. For example, processor 724 may be programmed with a counter that counts the number of clips that have been retrieved and displayed. In some implementations, the counter may count the length of time total spent by the clips and/or the total number of clips that are retrieved and displayed. The maximum number may be a total play time (e.g., 20 minutes) and/or a total number of media asset clips that are provided (e.g., 5 clips). When the maximum number has been reached, the process proceeds to step 1270, otherwise the process proceeds to step 1230.

At step 1270, a determination is made as to whether the last reaction of the user was negative. When the last reaction of the user was negative, the process proceeds to step 1280, otherwise the process proceeds to step 1210.

At step 1280, a clip is retrieved of the media asset having a rank higher than all other ranks of clips of the media asset that have not been displayed. For example, processor 724 may determine which clips stored in memory 726 have not been displayed and retrieve one of the clips that has not been displayed and that is associated with a high class level rank. Processor 724 may retrieve a clip from media server 710 a clip of the media asset associated with a high class level rank when no high class level rank clips that have not been displayed for the user are stored in memory 726. In some implementations, processor 724 may retrieve the highest ranked clip of the media asset stored in media asset clips storage device 740 (e.g., the clip having the highest rank among all high class level rank clips). The process then proceeds to step 1230.

It should be understood, that the above steps of the flow diagrams of FIGS. 10-12 may be executed or performed in any order or sequence no limited to the order and sequence shown and described in the figures. Also, some of the above steps of the flow diagrams of FIGS. 10-12 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for simulating dialog between a user and an actor presented on a media equipment device, the method comprising:
storing a plurality of videos of the actor, wherein the actor communicates a different message in each of the plurality of videos;
storing a plurality of clips of a media asset associated with the actor;
displaying a variable length sequence of media comprising first and second of the plurality of videos of the actor and at least one of the plurality clips of the media asset, wherein the at least one of the clips is in the sequence of media between the first and second videos of the actor;
monitoring verbal input of the user as the first video in the sequence is displayed; and
determining which of the plurality of clips to display as the at least one of the clips in the sequence of media based on the monitored verbal input.

2. The method of claim 1, wherein the message communicated by the actor in the first video of the plurality of videos includes a dialog opener, further comprising:
receiving a request from the user to have a dialog with the actor using the media equipment device;
retrieving for display the first video; and
monitoring verbal responses from the user to the first video.

3. The method of claim 2, wherein the actor communicates a dialog opener in a set of the plurality of videos of the actor, and wherein the first video is selected from the set, further comprising:
determining whether the user previously had a dialog with the actor; and
identifying which of the plurality of videos in the set have previously been presented to the user; and
selecting, as the first video, one of the videos in the set which have not been previously presented to the user.

4. The method of claim 2, wherein the variable length sequence further comprises a third video of the plurality of videos of the actor positioned after the first video, wherein the message communicated by the actor in the third video includes a description of the media asset, further comprising:
determining based on the verbal response from the user whether the user has previously accessed the media asset;
positioning the at least one clip after the third video when the user has not previously accessed the media asset; and
adding, to the variable length sequence, a fourth video of the plurality of videos of the actor, wherein the fourth video is positioned after the third video when the user has previously accessed the media asset and the at least one clip is positioned after the fourth video when the user has previously accessed the media asset.

5. The method of claim 1 further comprising:
continuously monitoring further verbal input as each media in the sequence is displayed;
selecting at least one of a third video of the plurality of videos of the actor and another clip of the plurality of clips based on the monitored further verbal input; and
adding, to the sequence of media, the selected at least one of the third video and another clip, wherein the length of the sequence varies based on the adding.

6. The method of claim 1, wherein the variable length sequence further comprises a third video of the plurality of videos of the actor positioned after the first video, wherein the actor communicates a ploy as the message in a set of the plurality of videos, further comprising:
associating the first video of the plurality of videos with a set of expected responses;
applying voice recognition to the monitored verbal input to determine whether the verbal input matches one of the expected responses in the set of expected responses associated with the first video that is displayed; and
selecting as the third video one of a plurality of videos in the set of the plurality of videos when the expected response does not match one of the expected responses.

7. The method of claim 6, wherein the ploy in the selected one of the plurality of videos in the set comprises a message that includes a description of the media asset, further comprising:
retrieving for display the selected one of the plurality of videos in the set; and
receiving verbal response from the user to the selected one of the plurality of videos in the set that is displayed;
wherein the clip to display as the at least one clip is determined based on the verbal response received from the user.

8. The method of claim 6 wherein the ploy in the selected one of the plurality of videos in the set comprises a message that includes subject matter associated with the voice recognized verbal input.

9. The method of claim 6 wherein the ploy in the selected one of the plurality of videos in the set comprises a message that includes a request for the user to repeat the response to the first video.

10. The method of claim 6 wherein the ploy in the selected one of the plurality of videos in the set comprises a message that makes the actor appear to the user as being interested in the response received.

11. The method of claim 6 wherein the one of the plurality of videos in the set is selected at random.

12. The method of claim 1 further comprising:
displaying a list of actors which are available for dialog simulation using the media equipment device; and
receiving a user selection of one of the actors in the list.

13. The method of claim 12 further comprising:
retrieving from a remote database a plurality of videos of the selected one of the actors, wherein the selected one of the actors communicates a different message in each of the retrieved plurality of videos; and
storing, as the stored plurality of videos of the actor, the videos retrieved from the remote database.

14. The method of claim 1, wherein the actor communicates a dialog ending segment in a set of the plurality of videos, further comprising:
identifying which of the plurality of videos in the set have previously been presented to the user; and
displaying as the second video one of the videos in the set which have not been previously presented to the user.

15. The method of claim 14, further comprising:
determining that the verbal input corresponds to an instruction to end the dialog;
wherein the identifying and displaying are performed in response to the determining.

16. The method of claim 1 further comprising:
associating a rank for each of the plurality of stored clips of the media asset according to a level of interest to the user; and
determining which of the clips to display as the at least one clip based on the associated rank of the clips.

17. The method of claim 16 wherein the determined clip is associated with a higher rank than all the other clips.

18. The method of claim 16, wherein the variable length sequence further comprises a second clip of the plurality of clips of the media asset, wherein the second clip follows the at least one clip and precedes the second video, further comprising:
detecting a reaction of the user to the displayed at least one clip;
adding to the variable length sequence a third video of the plurality of videos of the actor positioned after the at least one clip and before the second clip; and
determining which of the plurality of clips of the media asset to display as the second clip based on the reaction of the user.

19. The method of claim 18, wherein determining which of the plurality of clips to display as the second clip comprises:
selecting a clip associated with a rank lower than the rank of the at least one clip when the reaction is positive; and
selecting a clip associated with a rank higher than the rank of the at least one clip when the reaction is negative.

20. The method of claim 18, wherein detecting the reaction comprises:
monitoring verbal utterances made by the user while the first clip is displayed; and
determining whether the verbal utterances are associated with a negative or a positive reaction.

21. The method of claim 20, wherein determining whether the verbal utterances are associated with the negative or positive reaction comprises:
maintaining a user voice profile which includes a mapping between voice information associated with the user and negative or positive reactions.

22. The method of claim 20, wherein:
monitoring the verbal utterances comprises detecting absence of expected verbal utterances at predetermined playback time periods of the first clip; and
verbal utterances are determined to be associated with a negative reaction when the absence of expected verbal utterances are detected.

23. The method of claim 22 further comprising terminating playback of the first clip in response to detecting the absence of expected verbal utterances.

24. The method of claim 1 wherein the plurality of clips of the media asset are short segments of one or more episodes of a show in which the actor is a character or short segments presented at some point within an instance of a show in which the actor is present.

25. The method of claim 1 wherein each of the clips are longer in runtime than the videos of the actor by at least one order of magnitude.

26. The method of claim 1 further comprising providing video and audio continuity between first and second videos of the actor.

27. A system for simulating dialog between a user and an actor presented on a media equipment device, the system comprising:
a display;
a memory; and
processing circuitry configured to:
store in the memory a plurality of videos of the actor, wherein the actor communicates a different message in each of the plurality of videos;
store in the memory a plurality of clips of a media asset associated with the actor;
display on the display a variable length sequence of media comprising first and second of the plurality of videos of the actor and at least one of the plurality clips of the media asset, wherein the at least one of the clips is in the sequence of media between the first and second videos of the actor;
monitor verbal input of the user as the first video in the sequence is displayed; and
determine which of the plurality of clips to display as the at least one of the clips in the sequence of media based on the monitored verbal input.

28. The system of claim 27, wherein the message communicated by the actor in the first video of the plurality of videos includes a dialog opener, wherein the processing circuitry is further configured to:
receive a request from the user to have a dialog with the actor using the media equipment device;
retrieve from the memory for display on the display the first video; and
monitor verbal responses from the user to the first video.

29. The system of claim 28, wherein the actor communicates a dialog opener in a set of the plurality of videos of the actor, and wherein the first video is selected from the set, wherein the processing circuitry is further configured to:
determine whether the user previously had a dialog with the actor; and
identify which of the plurality of videos in the set have previously been presented to the user; and
select, as the first video, one of the videos in the set which have not been previously presented to the user.

30. The system of claim 28, wherein the variable length sequence further comprises a third video of the plurality of videos of the actor positioned after the first video, wherein the message communicated by the actor in the third video includes a description of the media asset, wherein the processing circuitry is further configured to:
determine based on the verbal response from the user whether the user has previously accessed the media asset;
position the at least one clip after the third video when the user has not previously accessed the media asset; and
add, to the variable length sequence, a fourth video of the plurality of videos of the actor, wherein the fourth video is positioned after the third video when the user has previously accessed the media asset and the at least one clip is positioned after the fourth video when the user has previously accessed the media asset.

31. The system of claim 27 wherein the processing circuitry is further configured to:
continuously monitor further verbal input as each media in the sequence is displayed;
select at least one of a third video of the plurality of videos of the actor and another clip of the plurality of clips based on the monitored further verbal input; and
add, to the sequence of media, the selected at least one of the third video and another clip, wherein the length of the sequence varies based on the adding.

32. The system of claim 27, wherein the variable length sequence further comprises a third video of the plurality of videos of the actor positioned after the first video, wherein the actor communicates a ploy as the message in a set of the plurality of videos, wherein the processing circuitry is further configured to:
associate the first video of the plurality of videos with a set of expected responses;
apply voice recognition to the monitored verbal input to determine whether the verbal input matches one of the expected responses in the set of expected responses associated with the first video that is displayed; and
select as the third video one of a plurality of videos in the set of the plurality of videos when the expected response does not match one of the expected responses.

33. The system of claim 32, wherein the ploy in the selected one of the plurality of videos in the set comprises a message that includes a description of the media asset, wherein the processing circuitry is further configured to:
retrieve from the memory for display on the display the selected one of the plurality of videos in the set; and
receive verbal response from the user to the selected one of the plurality of videos in the set that is displayed;
wherein the clip to display as the at least one clip is determined based on the verbal response received from the user.

34. The system of claim 32 wherein the ploy in the selected one of the plurality of videos in the set comprises a message that includes subject matter associated with the voice recognized verbal input.

35. The system of claim 32 wherein the ploy in the selected one of the plurality of videos in the set comprises a message that includes a request for the user to repeat the response to the first video.

36. The system of claim 32 wherein the ploy in the selected one of the plurality of videos in the set comprises a message that makes the actor appear to the user as being interested in the response received.

37. The system of claim 32 wherein the one of the plurality of videos in the set is selected at random.

38. The system of claim 27 wherein the processing circuitry is further configured to:
display on the display a list of actors which are available for dialog simulation using the media equipment device; and
receive a user selection of one of the actors in the list.

39. The system of claim 38 wherein the processing circuitry is further configured to:
retrieve from a remote database a plurality of videos of the selected one of the actors, wherein the selected one of the actors communicates a different message in each of the retrieved plurality of videos; and
store, as the stored plurality of videos of the actor, the videos retrieved from the remote database.

40. The system of claim 27, wherein the actor communicates a dialog ending segment in a set of the plurality of videos, wherein the processing circuitry is further configured to:
identify which of the plurality of videos in the set have previously been presented to the user; and
display as the second video one of the videos in the set which have not been previously presented to the user.

41. The system of claim 40, wherein the processing circuitry is further configured to:
determine that the verbal input corresponds to an instruction to end the dialog;
wherein the processing circuitry performs the identifying and displaying in response to performing the determining.

42. The system of claim 27 wherein the processing circuitry is further configured to:
associate a rank for each of the plurality of stored clips of the media asset according to a level of interest to the user; and
determine which of the clips to display as the at least one clip based on the associated rank of the clips.

43. The system of claim 42 wherein the determined clip is associated with a higher rank than all the other clips.

44. The system of claim 42, wherein the variable length sequence further comprises a second clip of the plurality of clips of the media asset, wherein the second clip follows the at least one clip and precedes the second video, wherein the processing circuitry is further configured to:
detect a reaction of the user to the displayed at least one clip;
add to the variable length sequence a third video of the plurality of videos of the actor positioned after the at least one clip and before the second clip; and
determine which of the plurality of clips of the media asset to display as the second clip based on the reaction of the user.

45. The system of claim 44, wherein the processing circuitry is further configured to:
select a clip associated with a rank lower than the rank of the at least one clip when the reaction is positive; and
select a clip associated with a rank higher than the rank of the at least one clip when the reaction is negative.

46. The system of claim 44, wherein the processing circuitry is further configured to:
monitor verbal utterances made by the user while the first clip is displayed; and
determine whether the verbal utterances are associated with a negative or a positive reaction.

47. The system of claim 46, wherein the processing circuitry is further configured to:
maintain a user voice profile which includes a mapping between voice information associated with the user and negative or positive reactions.

48. The system of claim 46, wherein the processing circuitry is further configured to:
monitor the verbal utterances by detecting absence of expected verbal utterances at predetermined playback time periods of the first clip; and
verbal utterances are determined to be associated with a negative reaction when the absence of expected verbal utterances are detected.

49. The system of claim 48 wherein the processing circuitry is further configured to terminate playback of the first clip in response to detecting the absence of expected verbal utterances.

50. The system of claim 27 wherein the plurality of clips of the media asset are short segments of one or more episodes of a show in which the actor is a character or short segments presented at some point within an instance of a show in which the actor is present.

51. The system of claim 27 wherein each of the clips are longer in runtime than the videos of the actor by at least one order of magnitude.

52. The system of claim 27 further comprising providing video and audio continuity between first and second videos of the actor.

53-78. (canceled)
